(19) United States
(12) Patent Application Publication
(10) Pub. No.: US 2017/0278496 A1
(43) Pub. Date: Sep. 28, 2017

(54) INTERACTIVE STRINGED MUSICAL INSTRUMENT AND SYSTEM COMPRISING THE SAME

(71) Applicant: Shigan Technology, Beijing, Beijing (CN)

(72) Inventors: Long Lin, Beijing (CN); Bohan Zhang, Beijing (CN); Yan Zhao, Beijing (CN); Jun Song, Beijing (CN)

(21) Appl. No.: 15/466,493

(22) Filed: Mar. 22, 2017

(30) Foreign Application Priority Data
Mar. 22, 2016 (CN) 201610165863.3
Mar. 22, 2016 (CN) 201620216767.2
Mar. 22, 2016 (CN) 201620222305.1
Mar. 22, 2016 (CN) 201620225876.0

(51) Int. Cl. G10H 1/00; G09B 15/02; G10H 1/44; G10D 3/06; G10G 7/00

(52) U.S. Cl. CPC G10H 1/0016; G10D 3/06; G10G 7/00; G10H 1/44; G09B 15/023; G10H 2220/135; G10H 2220/051

(57) ABSTRACT

A stringed musical instrument is disclosed herein. The stringed instrument comprises a body, a head, a neck, and one or more strings. The neck has a back plate and a cover integrated with the back plate. The back plate comprises a first array of openings and the cover comprises a second array of openings. The first array and second array of openings align to form an array of light housings. Each light housing is configured to house a light (e.g., LEDs). Also disclosed herein is an interactive stringed musical instrument teaching system comprising a stringed instrument and a mobile terminal (e.g., computer). Both the smart stringed instrument and the mobile terminal are in communication via one or more communication modules. The mobile terminal comprises a microphone, a tuning module, a database, a teaching module and a game module. The stringed instrument comprises a main control module, a sound wake-up module, an LED driver module and an LED matrix module.

### CROSS-REFERENCE TO RELATED APPLICATIONS

This application claims priority to and the benefit of Chinese Utility Model Patent Application No. 201620225876.0 filed on Mar. 22, 2016, Chinese Utility Model Patent Application No. 201620222305.1 filed on Mar. 22, 2016, Chinese Utility Model Patent Application No. 201620216767.2 filed on Mar. 22, 2016, and Chinese Patent Application No. 201610165863.3 filed on Mar. 22, 2016, the disclosures of which are incorporated herein by reference in their entirety.

### BACKGROUND OF THE INVENTION

A stringed musical instrument is an important branch of the instrument family. Almost all melodies from classical music to modern light music are played in part using stringed instruments. Based on how sound is produced, stringed instruments are divided into bow stringed instruments (e.g., the violin family), pizzicato stringed instruments (e.g., guitars and other plucked stringed instruments) and slap stringed instruments (e.g., piano). Examples of bow stringed instruments include the violin, viola, cello, double bass, and Erhu. Examples of pizzicato stringed instruments include the harp, guitar, electric guitar, electric bass, old lute, Pipa, and zither. Examples of slap stringed instruments include the piano. A guitar is a plucked instrument usually with six strings but it can also have four, eight, ten or twelve strings. Its shape is similar to that of a violin.

Currently, most people learn stringed instruments, such as the guitar, from teachers in classes, with high costs and short class time. There is an illusion that it is extremely difficult to learn to play the guitar because of a tedious teaching process, students' failure to persistently practice the guitar for a long time and other factors. Thus, there is a need for a modern interactive musical instrument and a teaching system to solve the problems mentioned above.

### SUMMARY OF THE INVENTION

The present disclosure relates to a stringed musical instrument, such as a guitar or ukulele with integrated LED lights and systems comprising the same. Also disclosed herein are methods of using the same.

In one embodiment, the stringed musical instrument comprises at least one string, a body, a head and a neck comprising a back plate and a cover. The back plate comprises a first array of openings and the cover comprises a second array of openings. The first array of openings is in alignment with the second array of openings forming a light housing array. At least one light housing of the light housing array is configured to house a light source.

In some embodiments, the cover comprises an upper surface, the upper surface comprises a plurality of circular notches. The plurality of circular notches substantially surrounds each of the second array of openings.

In some embodiments, the light housing array has 1, 2, 3, 4, 5, 6, 7, 8, 9, or 10 light housings in a row. For example, the number of light housings per row correspond to the number of strings of the stringed instrument. In one embodiment, the stringed instrument is a ukulele having 4 strings. Therefore, the light housing array has 4 light housings in each row. In another embodiment, the stringed instrument is a guitar having 6 strings. Therefore, the light housing array has 6 light housings in each row.

In some embodiments, the light housing array can have about 10 to about 30 (e.g., 10, 11, 12, 13, 14, 15, 16, 17, 18, 19, 20, 21, 22, 23, 24, 25, 26, 27, 28, 29 or 30) rows of light housings spaced apart along the neck of the stringed instrument. In some embodiments, the number of rows of light housings substantially corresponds to the number of frets of the stringed instrument. In one embodiment, the stringed instrument can have 12 rows of light housings. In one embodiment, the stringed instrument can have 15 rows of light housings. In one embodiment, the stringed instrument can have 18 rows of light housings. In one embodiment, the stringed instrument can have 20 rows of light housings. In some embodiments, the stringed instrument comprises at least 5 rows of light housings. In some embodiments, the stringed instrument comprises at least 10 rows of light housings. In some embodiments, the stringed instrument comprises at least 15 rows of light housings. In some embodiments, the stringed instrument comprises at least 20 rows of light housings. In some embodiments, the stringed instrument comprises at least 25 rows of light housings.

The first array of openings and the second array of openings form a plurality of light housings in a light housing array. The light housing array is the total number of light housings and relates to the number of light sources (e.g., one or more LEDs) the stringed instrument can have. For example, a light housing array having 20 rows and 6 openings in each row has a total of 120 light housings. By way of another example, a light housing array having 18 rows and 4 openings in each row has a total of 72 light housings. The light housing array can be sized and configured to fit the stringed instrument.

In some embodiments, the at least one string sits above the at least one light housing.

In some embodiments, the stringed instrument further comprises a plurality of frets, wherein each of the plurality of frets aligns with each row of openings.

In some embodiments, the light source in the stringed musical instrument is a LED. Each LED is housed in each light housing. Each LED has a diameter between 2.0 mm and 3.5 mm (e.g., 2.0, 2.1, 2.2, 2.3, 2.4, 2.5, 2.6, 2.7, 2.8, 2.9, 3.0, 3.1, 3.2, 3.3, 3.4 or 3.5). For example, the diameter of each LED is 2.8 mm.

In some embodiments, the circular notch has an inner diameter between 3 mm and 5 mm.

The present disclosure also relates to an interactive stringed instrument teaching system. The system comprises a stringed instrument comprising a first communication module and a mobile terminal (e.g., computer, mobile phone, mobile device, tablet) comprising a second communication module in communication with the first communication module. The stringed instrument comprises at least one string, a body, a head, and a neck comprising a back plate and a cover. The back plate comprises a first array of openings and the cover comprises a second array of openings. The first array of openings is in alignment with the second array of openings forming a light housing array. At least one light housing of the light housing array is configured to house a light source.

In some embodiments, the mobile terminal further comprises a microphone configured to collect one or more sound signals from the stringed instrument, a tuning module configured to obtain frequency information based on the collected one or more sound signals; and a database configured to store one or more musical scores, one or more standard sounds, a user playing data or a combination thereof.

In some embodiments, the mobile terminal further comprises a teaching module and a game module, wherein each of the teaching module and the game module comprises a performance module, a sound comparison module, and a note recognition module. For example, the sound comparison module compares the collected one or more sound signals with the one or more standard sounds and outputs one or more comparison results.

In some embodiments, the system further comprises a main control module, a sound wake-up module, an LED driver module and an LED matrix module. For example, the teaching module and the game module send note data to the smart stringed instrument through the first and second communication modules, and the main control module transmits the note data to the LED driver module which controls a plurality of LED lights at corresponding positions in the LED matrix module.

In some embodiments, the note recognition module recognizes one or more notes as a single note, a chord or a combination of notes.

In another embodiment, the teaching module sends one or more instructions to the user based on the one or more comparison results.

In some embodiments, the sound comparison module determines a sound played by the user is different from the one or more standard sound, the performance module does not play a next note until the sound comparison module determines that the two sounds are the same.

In some embodiments, the game module sends one or more instructions to the user based on the one or more comparison results.

In some embodiments, the first communication module, the second communication module, or both is a Bluetooth module. The Bluetooth modules are used for data transmission between the smart stringed instrument and the mobile terminal.

In some embodiments, the game module can provide real-time instructions to a user based on the comparison result. The instructions specifically can comprise the performance module continuously plays the present score, the sound comparison module keeps comparing the sounds collected with the standard sounds till the score is finished, the sound comparison module records and exhibits the number of correct and wrong notes played by the user based on the comparison results.

In some embodiments, the teaching module and the game module can set different learning targets based on the difficulty of scores.

In some embodiments, the game module can also comprise a pattern recognition module, which determines game patterns based on the present score played. The game patterns include a waterfall flow pattern and a chord cycle pattern.

In some embodiments, the server can comprise a song library and a file conversion module. The song library can save score files generated by the file conversion module.

The present disclosure herein also relates to a communication and/or data connection between a stringed instrument, such as a guitar or ukulele, and a mobile terminal through a communication module such as a Bluetooth module. After a connection is established for the first time, the system can prompt the user to tune the stringed instrument.

In some embodiments, the system can pick up sounds played by the user through a microphone. Corresponding frequency information can be obtained based on the sounds collected. The system can also compare the frequency information with the standard frequency information. In some embodiments, the system instructs the user to tune the stringed instrument.

In some embodiments, the user can choose between a teaching module and a game module. When the user plays the present score, the microphone will continuously collect sounds. Then, the sound comparison module will compares the sounds collected with the standard ones to determine the user's correctness and provide real-time instructions based on the comparison result. After all game levels are finished, it will show problems in the user's playing session based on an analysis of the user playing sessions, and give an award to the user based on the playing result. Based on the data collected during the user's play, the system will instructions the user to practice the unfamiliar parts through an algorithm, to learn the playing skills through games from easy to difficult, and to give the user a feeling of achievement during the part which they are good at.

### BRIEF DESCRIPTION OF THE DRAWINGS

Exemplary embodiments of the present disclosure are described below and shown in the accompanying drawings.

FIG. 1 illustrates a structure of a stringed musical instrument according to some embodiments of the present disclosure.

FIG. 2 illustrates a structure drawing of a neck according to some embodiments of the present disclosure.

FIG. 3 illustrates a detailed drawing of the part labeled as B in FIG. 2.

FIG. 4 illustrates a cross-sectional view of the line A-A in FIG. 3.

FIG. 5 illustrates a system diagram of an interactive stringed instrument teaching system according to some embodiments of the present disclosure.

FIG. 6 is a block diagram of components in an interactive stringed instrument teaching system according to some embodiments of the present disclosure.

FIG. 7 is a block diagram of a communication module according to some embodiments of the present disclosure.

FIG. 8 is a block diagram of a power management module according to some embodiments of the present disclosure.

FIG. 9 is a block diagram of a LED driver module according to some embodiments of the present disclosure.

FIG. 10 is a connection diagram of a LED matrix module according to some embodiments of the present disclosure.

FIG. 11 is a block diagram of a sound wake-up module according to some embodiments of the present disclosure.

FIG. 12 illustrates a flow diagram of a light-on process in the smart stringed instrument according to some embodiments of the present disclosure.

FIG. 13 illustrates a flow diagram of a game module according to some embodiments of the present disclosure.

FIG. 14 illustrates a flow diagram of an interactive stringed instrument teaching system according to some embodiments of the present disclosure.

### DETAILED DESCRIPTION

Specific embodiments of the present disclosure are described below. These embodiments are being presented by way of example only. Numerous modifications and other embodiments are within the scope of one of ordinary skill in the art and are contemplated as falling within the scope of the present disclosure. In addition, those skilled in the art should appreciate that the specific conditions and configurations are exemplary and that actual conditions and configurations will depend on the specific system. Those skilled in the art will also be able to recognize and identify equivalents to the specific elements shown, using no more than routine experimentation.

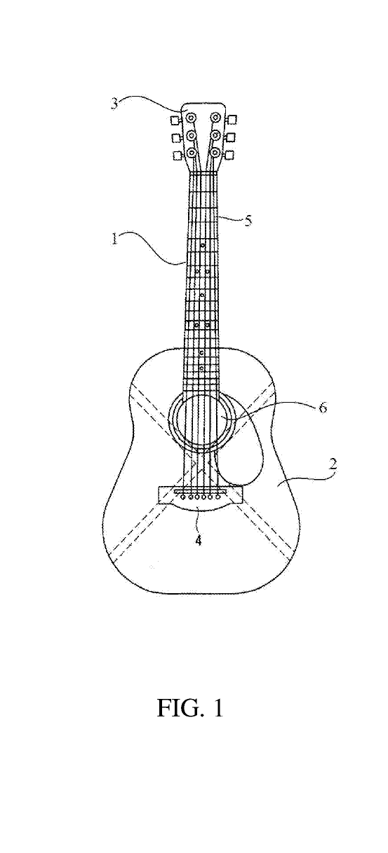

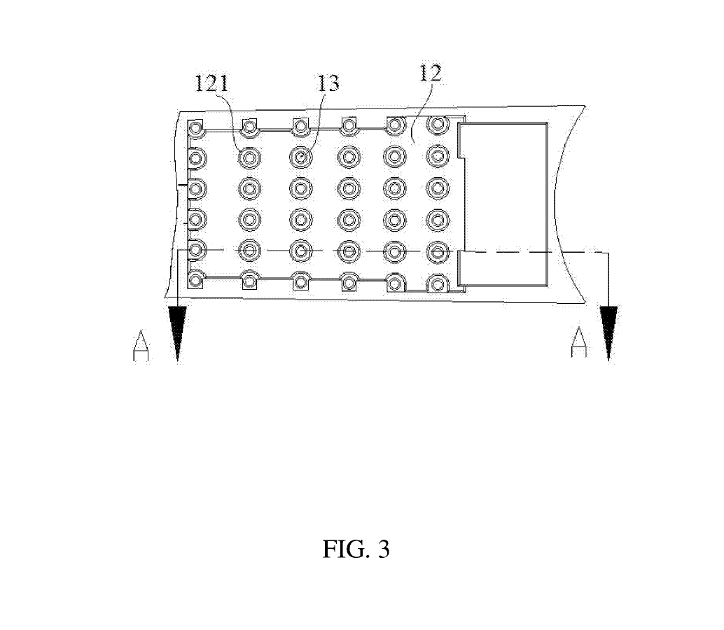

The present disclosure relates to a stringed musical instrument 10, as shown in FIGS. 1-4, comprising a body 2, a head 3, a neck 1 and at least one string 5. The neck 1 comprises a back plate 11 and a cover 12. Back plate 11 and cover 12 can be integrated forming neck 1 of musical instrument 10.

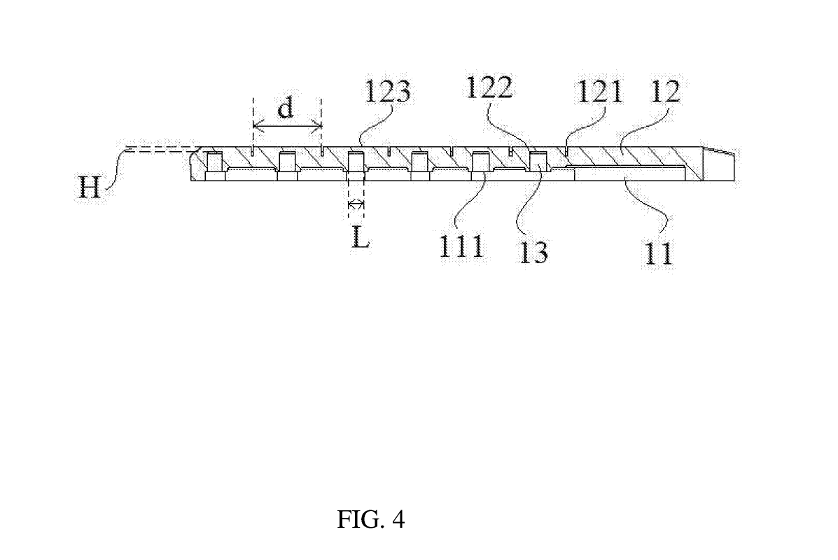

Back plate 11 can have a first array of openings 111. The lower surface of the cover 12 can comprise a second array of openings 122. The second array of openings 122 is in alignment with the first array of openings 111, forming a light housing array. Each light housing of the light housing array can house a LED light 13. The upper surface of the cover 12 can comprise circular notches 121 which align with the second array of openings 122. The lower surface of the cover 12 is the surface close to the back plate as shown in FIG. 4.

Each of the circular notches 121 can substantially surround each of the second array of openings 122, at the outskirts of the second array of openings 122.

The inner diameter d of the circular notches 122 can be 3-5 mm such as 3, 4, or 5 mm, with a preferred value of 3.5-4.5 mm such as 3.5, 3.6, 3.7, 3.8, 3.9, 4.0, 4.1, 4.2, 4.3, 4.4, or 4.5 mm.

The width of the circular notches 122 can be 0.1-1.5 mm, with a preferred value of 0.5-1 mm such as 0.5, 0.6, 0.7, 0.8, 0.9, or 1.0 mm.

Each of the second array of openings can act as an independent “hat” for the LED light. The circular notch can focus the light coming out of the LED, provide a cover 123 above each LED for decorative purposes and show the position of each fret.

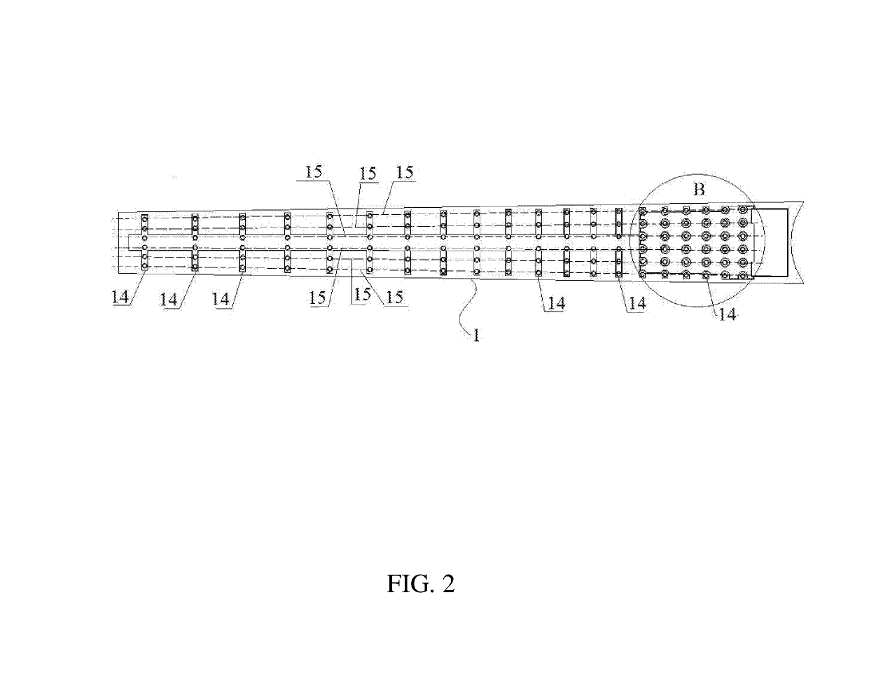

The light housing array 111 (or LED light) can comprise 3, 4, 5, or 6 light housings (or horizontal columns 15) in each row. FIG. 2. shows a stringed instrument with 6 light housing in each row. In some embodiments, the light housing array can between 10-30 vertical rows of light housings spaced apart along the neck of the stringed instrument. FIG. 2 shows a stringed musical instrument with 20 rows.

The stringed musical instrument 10 can have 3, 4, 5, or 6 strings 5, and each string 5 sits above a column of light housings. So each column of LED lights correspond to a single string 5. The twenty vertical rows of light housing 14 correspond to twenty frets on the strings. This design of the LED light housing array allows for each row of LED lights to correspond to one fret.

The LED lights 13 can be mounted inside the light housing array, so the positions of the LED lights 13 can be fixed.

The light housing array, the LED lights or both can be substantially cylinder-shaped or substantially cuboid-shaped. If they are cylinder-shaped, the diameter L can be about 2.0-3.5 mm, with a preferred value of about 2.5 mm or about 2.8 mm. If they are cuboid-shaped, their cross sectional shape is square (the shape of square can be seen from the top), with a length of each edge L being 2-3.5 mm, and a preferred value of 2.5 mm or 2.8 mm. The height for the LED lights can be 3-4 mm. The size of the LED lights affects the utility and visual effects of the instrument.

The height of the second array of openings 122 can be equal to the distance from the upper surface of the first array of openings 111 to the top of the LED lights 13. Thus the top of the LED lights 13 is close to the top of the second array of openings 122, as shown in FIG. 4.

In some embodiments, the thickness of the cover H on top of the LED lights 13 can be around 0.5-1.5 mm. So the distance H between the top of the LED lights and the outer surface of the cover can be 0.5-1.5 mm, with a preferred value of 1 mm, as shown in FIG. 4. A too thin or too thick cover can affect the visual effect produced by the LED lights within the light housing.

One end of the cover 12 is connected with the body 2 permanently or is releaseably attached. One end of the cover 12 can be mounted with the hole 6 in the body 2 and the other end of the cover 12 can be mounted to the head 3.

One end of the string 5 can be fixed at the support frame 4 and the other end can be fixed on the head 3, as shown in FIG. 1.

The cover can be made from dark black translucent materials. When the LED lights illuminate, there is a distinct comparison resulting a mix of music and lights.

It should be pointed out that the LED lights 13 are not exposed. Only the cover 123 formed by the circular notches 121 can be seen from outside. Because the cover 123 is dark black and translucent, the light can shine through the cover 123 when LED lights illuminate. If the cover 123 is clear and translucent, the LED lights inside can be easily seen.

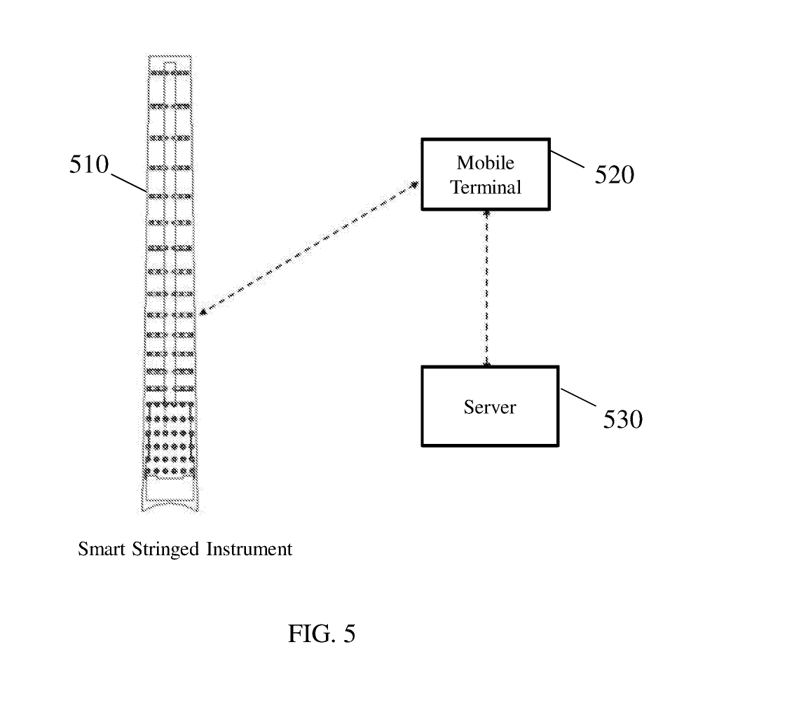

The present disclosure also relates to an interactive stringed instrument teaching system. FIG. 5 shows a diagram of the system according to some embodiments of the present disclosure. The system can comprise a smart stringed instrument 510, a mobile terminal 520 and a server 530.

Both the smart stringed instrument and the mobile terminal can comprise a communication module, such as a Bluetooth module, which are used for data transmission between the smart stringed instrument and the mobile terminal. The mobile terminal can also comprise a microphone, a tuning module, a database, a teaching module and a game module. The microphone collects sound signals from the smart stringed instrument. The tuning module obtains frequency information based on the sound signals collected by the microphone, and guides users to tune the smart stringed instrument. The database stores musical scores, standard sounds and user playing data. The teaching module and game module, both of which comprise a performance module, a sound comparison module and a note recognition module, are used to play the present musical score and compare the collected sound with the standard sound with the sound comparison module to determine a user's playing correctness and provide real-time instructions to the user based on the result.

The smart stringed instrument can comprise a main control module, a sound wake-up module, a LED driver module and a LED matrix module. The teaching module and the game module send each note in the present score to the smart stringed instrument via the communication module, and the main control module transmits the note data to the LED driver module, which controls the LED lights at corresponding note positions at the LED matrix module.

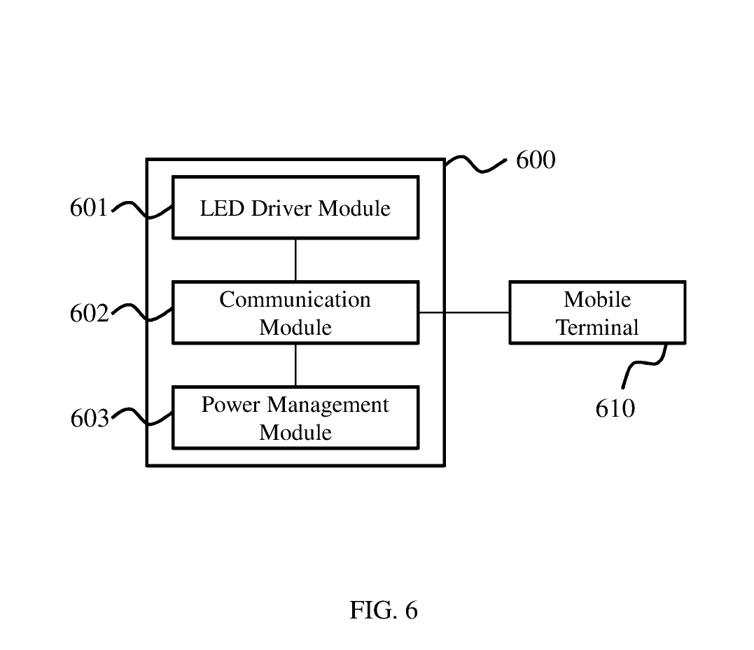

FIG. 6 shows a system diagram of an interactive stringed instrument teaching system according to some embodiment of the present disclosure. The system can comprise a smart stringed instrument and a mobile terminal 610. The smart stringed instrument can comprise a PCB board 600. The PCB board 600 can comprise a communication module 602, a LED driver module 601 and a power management module 603. The LED driver module 601 and the power management module 603 connect with the communication module 602. The communication module 602 connects to the mobile terminal 610 via a communication protocol, such as Bluetooth, Wi-Fi, etc.

The mobile terminal 610 can be a mobile device such as a mobile phone. In some embodiments, the mobile terminal 610 can be a tablet computer.

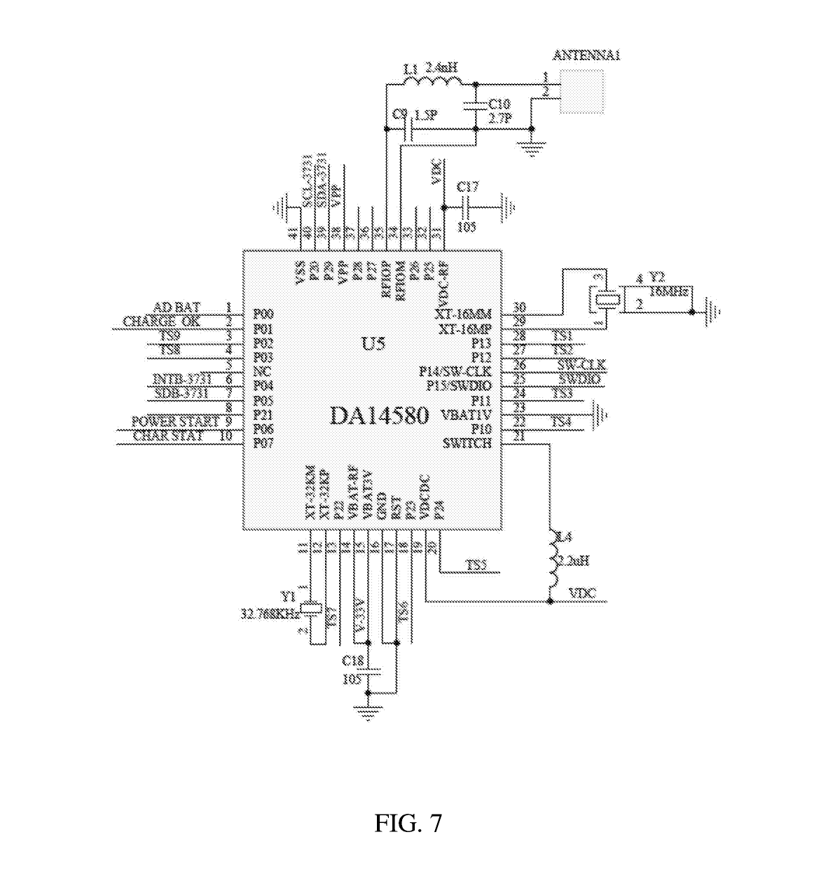

FIG. 7 shows a block diagram of the communication module 602 according to some embodiments of the present disclosure. The communication module 602 can comprise a BLE control IC with Bluetooth function or other IC with similar functions. As shown in FIG. 7, the AD port is a detection port for battery charging. The I2C port connects with a LED driver IC. The GPIO port is used for wake-up detection and charging detection.

The core of the communication module 602 can comprise a DA14580 IC with Bluetooth function, which provides Bluetooth communication and drives peripheral circuits. This results in a compact size and a low cost. The I2C port connects to a LED driver IC and controls the LED lights individually. The 10-bit AD port connects to a charging port (AD_BAT) and reads battery voltage. The IO port connects to a MIC port (power_start) for IC wake-up.

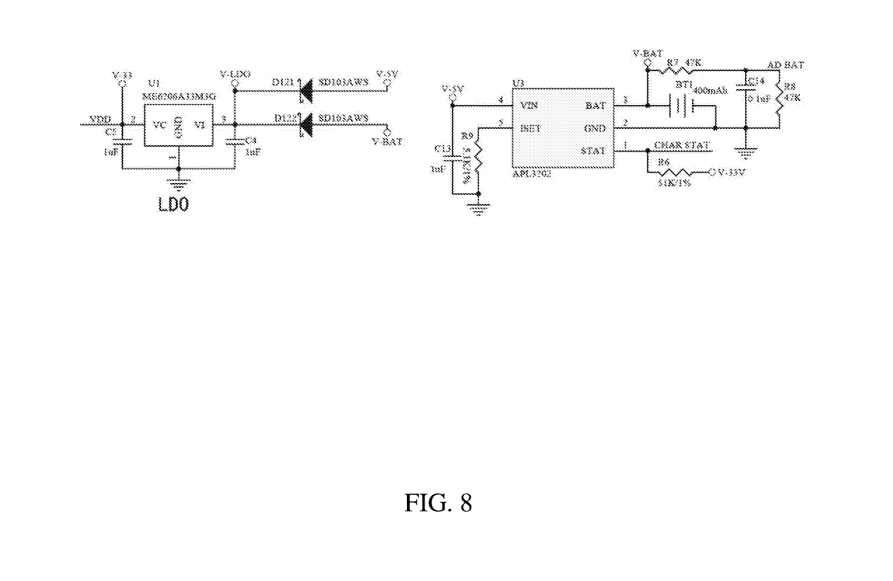

FIG. 8 shows a block diagram of the power management module 603 according to some embodiments of the present disclosure. The power management module 603 can comprise a charging module and a discharging module. It can utilize a wireless charging technique, such as Qi™ wireless charging.

The power management module 603 can comprise a LDO IC and a charging management IC such as APL3202. The LDO IC output a voltage of 3.0 V for the main control IC. The charging management IC (APL3202) can prevent the battery from over-discharging, over-charging, high voltage, and high temperature, and prolong the battery's lifetime. The AD_BAT port connects to the AD port of the main control IC for real-time charging detection. The CHAR_STAT port provides a charging status to the main control IC.

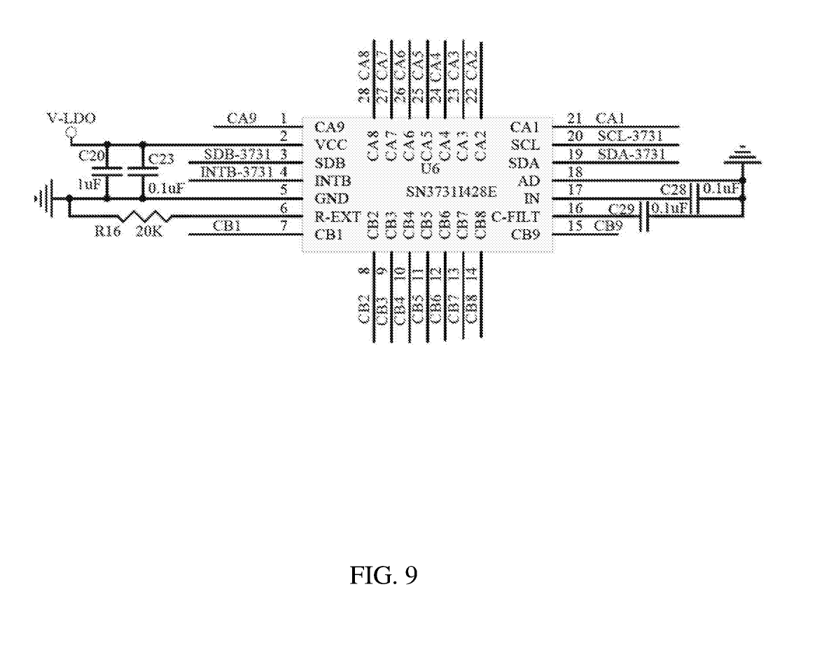

FIG. 9 shows a block diagram of the LED driver module 601 according to some embodiments of the present disclosure. The LED driver module 601 can connect to the LED lights 13. The LED driver module 601 can comprise a LED matrix module.

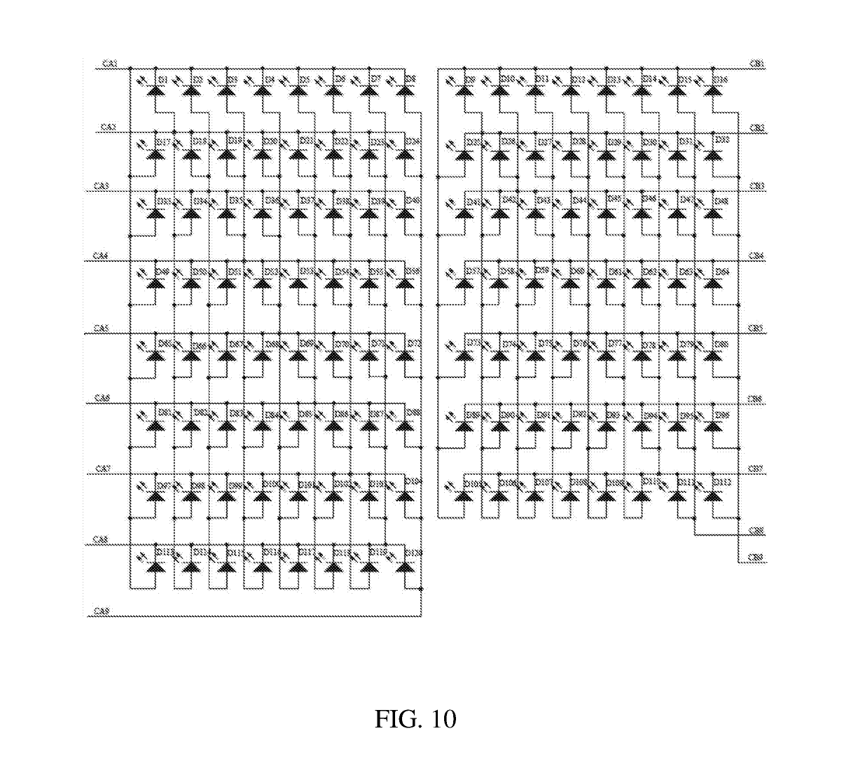

In some embodiments, the LED driver module 601 can comprise a LED driver IC such as SN3731I428E, which drives the LED matrix with simple I2C commands, as shown in FIGS. 9-10. The LED driver module controls the on and off of the LED matrix, as well as dim levels of each LED light.

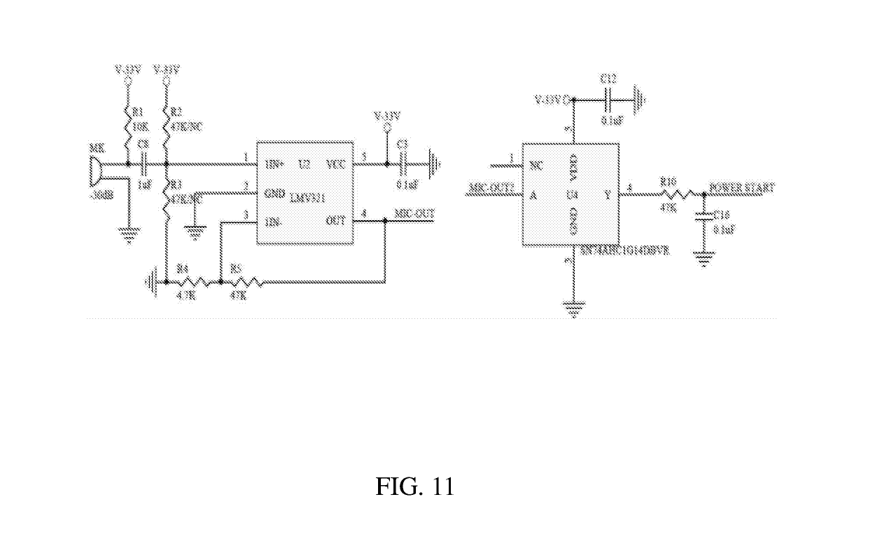

The PCB board 600 can comprise a sound wake-up module which connects to the communication module 602. FIG. 11 shows a block diagram of a sound wake-up module according to some embodiments of the present disclosure. The wake-up module can comprise a MIC receiver module (−30 db), a LMV321 signal operation amplifier and a SN74AHC1G14DBVR single Schmidt-trigger inverter. The signals collected by the MIC receiver module are very weak, and they need to be amplified by the LMV321 operation amplifier. Because digital circuits cannot process analog signals, such signals can be corrected by the SN74AHC1G14DBVR before they are sent to the main control IC. The IC will wake up upon receiving a signal from the MIC. With the sound wake-up module, the equipment will wake up automatically from a sleep mode when a user plucks the strings of the guitar and the volume exceeds 70 db.

The note recognition module can recognize one or more notes as a single note, chord or combination of other notes.

The teaching module can provide real-time instructions to the user based on the result. The instructions can comprise: when the sound comparison module determines that the note played by the user is different from the standard sound, the performance module cannot play the next note until the system determines that the two sounds are the same.

The game module can provide real-time instructions to the user based on the result. The instructions can comprise: the performance module continuously plays the present score; the sound comparison module keeps comparing the sounds collected with the standard sounds until the score is finished; the sound comparison module records and shows the number of correct and wrong notes played by the user based on the comparison result.

The teaching module and the game module can set different learning targets based on the difficulty of the scores.

The game module can comprise a pattern recognition module, which determines game patterns based on the present score played. The game patterns can comprise a waterfall flow pattern and a chord cycle pattern.

The server can comprise a song library and a file conversion module. The song library saves score files generated by the file conversion module. The file conversion module converts score files of different formats into a file format in compliance with the software program's requirements. For example, a user can upload scores in “guitar pro” format to the server, and the server can convert the files uploaded by the user into score files in the format that is used by the software program, so that other users can also play.

Some modules of the mobile terminal of the present disclosure can be realized either with software or with hardware. For example, the tuning module, the database, the teaching module and the game module can be altogether combined in one software program. All functions of the modules can be realized by running the software program. Additionally, it can also simplify the product operations and enhance human-machine interaction.

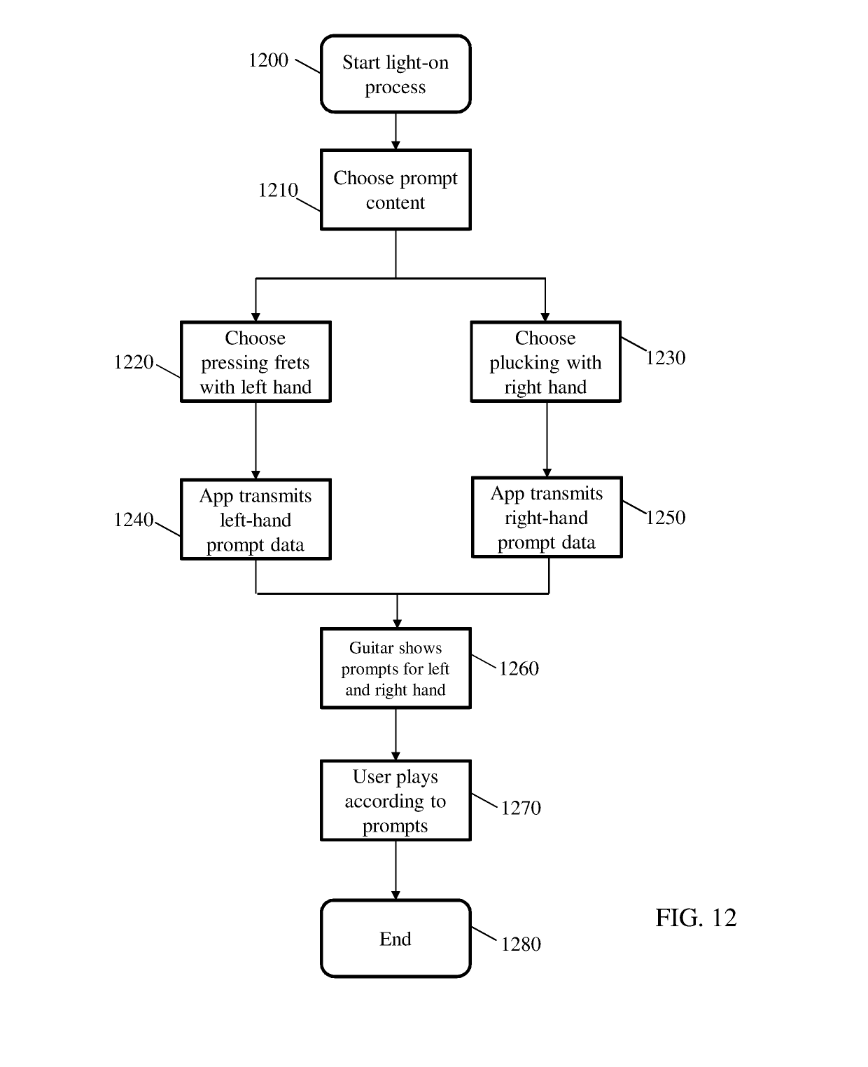

FIG. 12 is a flow diagram of the LED lights-on process when a user plays the guitar by pressing the frets with left hand and plucking the strings with right hand according to some embodiments of the present disclosure. Specifically, the user first starts the communication module in the smart stringed instrument and the mobile terminal, and starts the light-on process in 1200. After a communication connection is established, the user chooses a mode in 1210 in which the user can press the frets with left hand in 1220 and pluck the strings with right hand in 1230. Then, the mobile terminal will transmit the mode selection data to the smart stringed instrument in 1240 and 1250, whose LED matrix will turn on at the corresponding positions of left and right hands in 1260. The user can follow the prompts in 1270 to finish the whole light-on process in 1280.

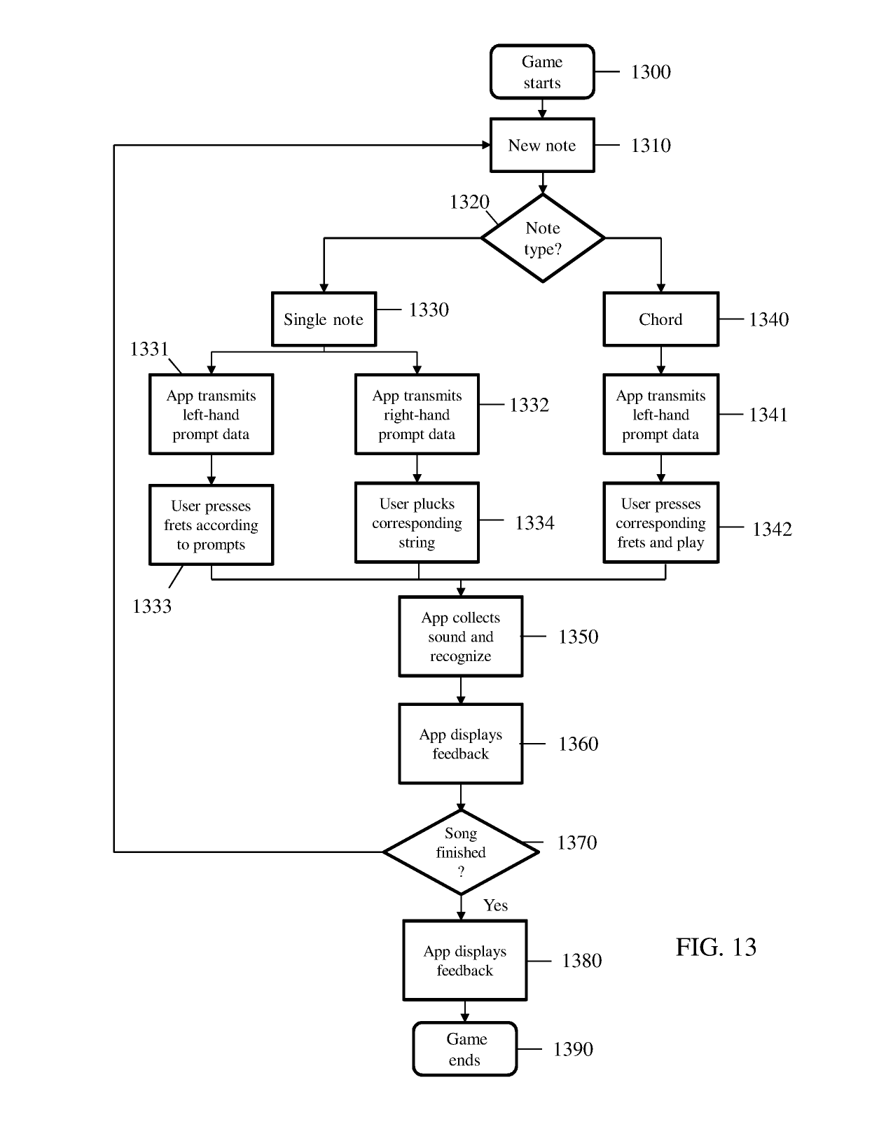

As shown in FIG. 13, the user starts the communication module in the smart stringed instrument and the mobile terminal. After a connection is established, the user can select a game mode in which a present score is played in 1300. The note recognition module can recognize the type of notes in 1320. When the notes are single ones in 1330, the mobile terminal will send prompt data for left hand in 1331 and right hand in 1332, and the user can press frets in 1333 and pluck strings in 1334 accordingly. When a chord is detected in 1340, the mobile terminal will send prompt data for left hand in 1341. Following the prompts, a user can press the corresponding frets with the left hand and play the instrument following the score played by the performance module in 1342. In 1350, the sound comparison module in the mobile terminal will compare the collected sounds played by the user with the standard sounds to determine the user's correctness and send the result to the mobile terminal to be displayed in 1360. After the score is finished in 1370, the result will be shown in 1380 and the game learning session is finished in 1390.

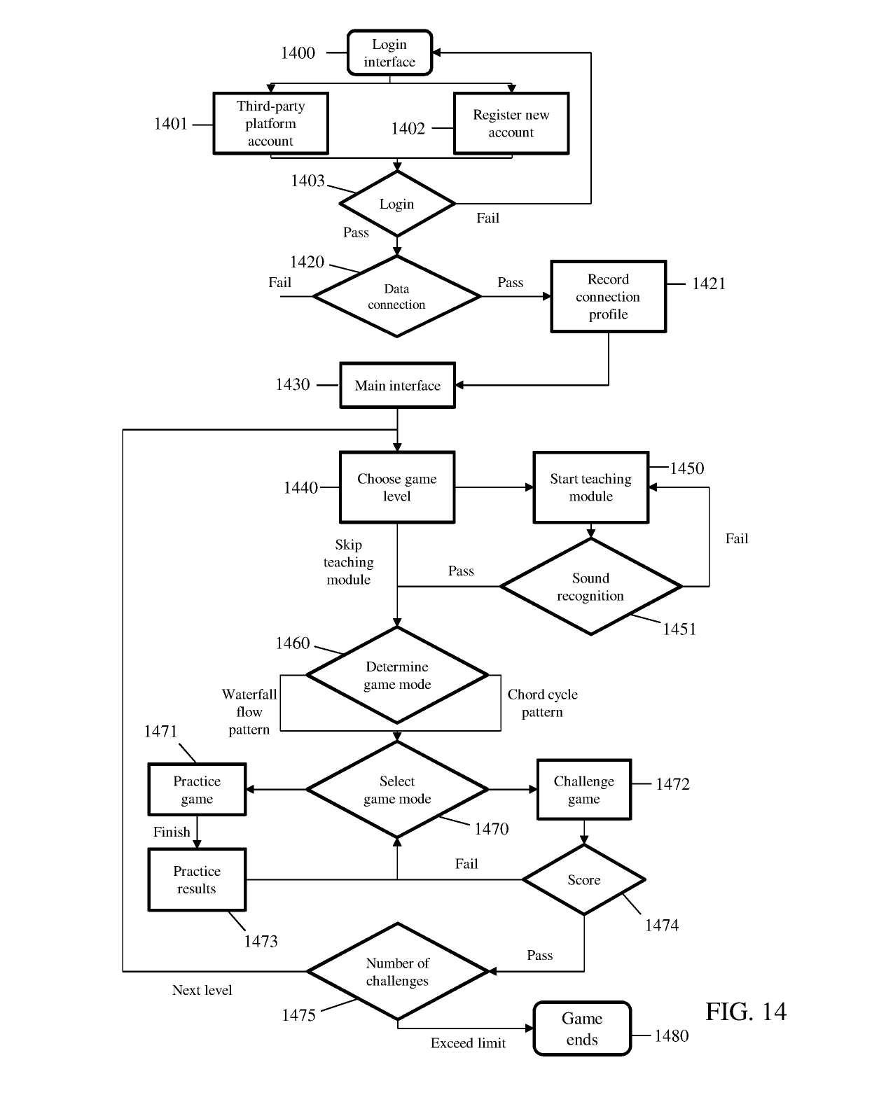

As shown in FIG. 14, at the login interface of the system 1400, the user can choose to login with a third party platform account in 1401 or to register a new account in 1402. After the login is successful in 1403, the user can start the communication module in the smart stringed instrument and the mobile terminal in 1420. After a connection is established, the connection profile is recorded in 1421. The user is directed to the main interface in 1430. The user can choose the game module in 1440 or the teaching module in 1450. When the teaching module is selected, the user can get familiar with the position of each note in 1451. Beginners can use this module. A user familiar with the instrument can skip the teaching module and select the game module. The mode recognition module determines the game modes according to the present score in 1460. The game modes can comprise a waterfall flow mode and a chord cycle mode. In 1470, the user can also select a game category such as a practice game 1471 or a challenge game 1472. The system can collect the user playing data 1473, including correctness, error rate, etc., during the game session, and calculate a score in 1474. Finally, the system determines the user's number of challenges of the day in 1475. When the number of challenges exceeds a preset value, the system can stop the game in 1480.

Compared with the existing techniques, this present disclosure provides the following advantages. The present disclosure establishes a communication connection between a stringed instruments, and a mobile terminal through the communication module. After a connection is established for the first time, the system can require the user to tune the stringed instrument and collect sounds played by users via the microphone. Based on the sounds, the corresponding frequency information can be obtained. After the system compares the frequency information with the standard frequency information, it guides the user to tune strings. There are two categories of learning session available to users, teaching and game. When a user plays the present score, the microphone will continuously collect sounds. Then, the sound comparison module will compares the sounds collected with the standard ones to determine the user's correctness and provide real-time instructions based on the results. After all game levels are finished, it can show problems during the user's playing session based on its analysis, and can give an award to the user based on the results. Based on the data generated during the play session, the system can instructions the user to practice unfamiliar parts in later learning sessions through an algorithm.

The foregoing description of preferred embodiments of the present disclosure has been presented for the purpose of illustration and description. It is not intended to be exhaustive or to limit the invention to the precise forms disclosed. Modifications and variations are possible in light of the above teachings, or can be acquired from practice of the invention. The embodiments presented herein were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A stringed instrument comprising:
at least one string;
a body;
a head; and
a neck comprising a back plate and a cover;
wherein the back plate comprises a first array of openings and the cover comprises a second array of openings;
wherein the first array of openings is in alignment with the second array of openings forming a light housing array; and
wherein at least one light housing of the light housing array is configured to house a light source.

2. The stringed instrument of claim 1, wherein the cover comprises an upper surface, the upper surface comprises a plurality of circular notches.

3. The stringed instrument of claim 2, wherein each of the plurality of circular notches substantially surrounds each of the second array of openings.

4. The stringed instrument of claim 1, wherein the light housing array has 3, 4, 5, or 6 light housings in each row.

5. The stringed instrument of claim 4, further comprising 10 to 30 rows of light housings spaced apart along the neck of the stringed instrument.

6. The stringed instrument of claim 5, further comprising 20 rows of light housings.

7. The stringed instrument of claim 1, wherein each of the at least one string sits above the at least one light housing.

8. The stringed instrument of claim 7, further comprising a plurality of frets, wherein each of the plurality of frets aligns with each row of light housings.

9. The stringed instrument of claim 1, wherein the light source is a LED.

10. The stringed instrument of claim 9, wherein a LED is housed in each light housing.

11. The stringed instrument of claim 10, wherein a diameter of the LED is between 2.0 mm and 3.5 mm.

12. The stringed instrument of claim 11, wherein the diameter of the LED is 2.8 mm.

13. The stringed instrument of claim 3, wherein an inner diameter of the circular notch is between 3 mm and 5 mm.

14. The stringed instrument of claim 1, wherein the stringed instrument is a guitar or a ukulele.

15. An interactive stringed instrument teaching system comprising:
a stringed instrument comprising a first communication module and
a mobile terminal comprising a second communication module in communication with the first communication module;
wherein the stringed instrument comprises:
at least one string;
a body;
a head; and
a neck comprising a back plate and a cover;
wherein the back plate comprises a first array of openings and the cover comprises a second array of openings;
wherein the first array of openings is in alignment with the second array of openings forming a light housing array; and
wherein at least one light housing of the light housing array is configured to house a light source.

16. The system of claim 15, wherein the mobile terminal further comprises:
a microphone configured to collect one or more sound signals from the stringed instrument;
a tuning module configured to obtain frequency information based on the collected one or more sound signals; and
a database configured to store one or more musical scores, one or more standard sounds, a user playing data or a combination thereof.

17. The system of claim 16, wherein the mobile terminal further comprises a teaching module and a game module, wherein each of the teaching module and the game module comprises a performance module, a sound comparison module, and a note recognition module.

18. The system of claim 17, wherein the sound comparison module compares the collected one or more sound signals with the one or more standard sounds and outputs one or more comparison results.

19. The system of claim 17, further comprising a main control module, a sound wake-up module, an LED driver module and an LED matrix module.

20. The system of claim 19, wherein the teaching module and the game module send note data to the smart stringed instrument through the first and second communication modules, and the main control module transmits the note data to the LED driver module which controls a plurality of LED lights at corresponding positions in the LED matrix module.

21. The system of claim 18, wherein the note recognition module recognizes one or more notes as a single note, a chord or a combination of notes.

22. The system of claim 18, wherein the teaching module sends one or more instructions to the user based on the one or more comparison results.

23. The system of claim 18, wherein the sound comparison module determines a sound played by the user is different from the one or more standard sound, the performance module does not play a next note until the sound comparison module determines that the two sounds are substantially the same.

24. The system of claim 18, wherein the game module sends one or more instructions to the user based on the one or more comparison results.
